(19) United States
(12) Patent Application Publication
(10) Pub. No.: US 2009/0195390 A1
(43) Pub. Date: Aug. 6, 2009

(54) SECURITY TAG AND METHOD OF MANUFACTURING THE SAME

(75) Inventor: CHUAN-PING CHOU, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: WAYSEAL CO., LTD., TAIPEI COUNTY (TW)

(21) Appl. No.: 12/046,780

(22) Filed: Mar. 12, 2008

(30) Foreign Application Priority Data
Feb. 5, 2008 (TW) 097104471

(51) Int. Cl. G08B 13/00

(52) U.S. Cl. 340/572.8

(57) ABSTRACT

A security tag including a carrier film, a transparent glue, and one or more micro-sheets is provided. Each micro-sheet is provided with a specific engraved pattern with dimensions in the micron range. The transparent glue and the micro-sheets are mixed together in advance and then dropped on the surface of the carrier film for solidification. The micro-sheets with specific engraved pattern are randomly distributed within the transparent glue and compose a unique feature that is hardly reproduced. Thus, the security tag could provide an authentication of an article.

### BACKGROUND OF THE INVENTION

1. Field of the Invention

The present invention is related to a security tag and a method of manufacturing the same, and more particular to a security tag that is used for authentication by one or more micro-sheets with dimensions in the micron range.

2. Description of Related Art

In recent years, forgery has become a serious social problem. Fake goods, certificates, documents and etc. are spread over the market. Forgeries made by irregular manufacture not only could not prove the quality of themselves but also damage normal enterprises' benefit and reputation. Security design is a solution of forgery prevention. An effective security design should have features of easy identification and difficult implementation. Thus, even though the goods and the trademarks are copied, the forgery design could not be copied concurrently. It provides a key for the public to distinguish the false and the true.

Currently, all circles are aware of forgery prevention and detection and pay much attention to the development of security design. There are many kinds of security design applied in diversified field. The species of present security design to ensure an authentication of an article includes anti-counterfeit ink, embossing printing, bar-code, hologram label, radio-frequency identification (RFID), Biometrics, color security fibers, DataDot, and etc.

Among the security design mentioned above, anti-counterfeit ink, embossing printing, bar-code, hologram sticker are adopted on the goods popularly. The characteristic thereof consists in the simple identification. But based on such a characteristic, it is easy to copy these security features. For example, a hologram label provides an authentication with a hologram pattern formed on a holographic film by a special equipment according to the laser holography technology. However, once the holographic film is obtained on purpose for copying the label illegally, the consumers will still be cheated because of visual mistakes resulted from the holographic film and the hologram label would lose the security effect of the true. Radio-frequency identification and Biometrics are implemented by higher level techniques and are hardly reproduced. However, an associating reading device and analysis are necessary for accomplishing identification so as to make the authentication inconvenient.

Color security fibers provides an authentication by the color or fluorescent fibers distributed on a paper. The color fibers are placed onto the paper pulp and after the pulp dries, these fibers would compose a unique hidden mark. Color security fibers applies to ensure authentications of paper articles, such as documents, certificates, paper labels, and etc. DataDot technology provides an authentication by a large number of plastic micro-dots with data recorded thereon. Necessary data is recorded on the micro-dots by laser printing and the micro-dots are stuck onto the surface of an article by adhesive. Color security fibers and DataDot technology only suit special species of articles so that the application region is narrow.

The security design set above have individual drawbacks. An effective security design should concurrently have features consisting in easy identification, difficult reproduction, and flexible integration to various products.

### SUMMARY OF THE INVENTION

Accordingly, an objective of the present invention is to provide a security tag and a method of manufacturing the same that could be attached onto various articles by flexibly changing the species of the carrier film which carries a transparent glue mixed with one or more micro-sheets.

Another objective of the present invention is to provide a security tag and a method of manufacturing the same that could raise difficulties over manufacture substantially so as to prevent reproduction the security tag by forming the micro-sheet with a specific engraved pattern by manufacture at the micron level.

Another objective of the present invention is to provide a security tag and a method of manufacturing the same that could provide an authentication for an article by a unique feature that is hardly reproduced composed by one or more micro-sheets distributed randomly inside the transparent glue.

The present invention provides a security tag. The security tag includes a carrier film, a transparent glue and at least one micro-sheet. The carrier film includes a top surface. The transparent glue is disposed on the top surface of the carrier film. The micro-sheet is randomly disposed within the transparent glue and provided with a specific engraved pattern with dimensions in the micron range.

The present invention further provides a method of manufacturing a security tag. The method according to the invention firstly is to provide a carrier film. Next, a transparent glue mixed with at least one micro-sheet, which is provided with a specific engraved pattern with dimensions in the micron range, is dropped on a top surface of the carrier film. Lastly, the transparent glue is solidified.

Therefore, the security tag and the method of manufacturing the same of the present invention could provide an authentication of an article by the specific engraved pattern of the micro-sheet fabricated by manufacture at the micron level that raises difficulties of copying the security tag substantially.

Besides, the micro-sheets and the transparent glue are mixed in advance and then dropped on the carrier film for solidification. Thus, the micro-sheets are randomly distributed within the transparent glue and compose a unique feature that could provide an authentication. Moreover, the security tag could be attached onto different articles, such as a commercial electrical device, a paper document, a certificate, and etc., varying from the customer requirements.

The objective of the present invention will no doubt become obvious to those of ordinary skill in the art after reading the following detailed description of the preferred embodiment, which is illustrated in the various figures and drawings.

### BRIEF DESCRIPTION OF THE DRAWINGS

The present invention can be fully understood from the following detailed description and preferred embodiment with reference to the accompanying drawings, in which:

FIG. 1 is a top view showing a security tag according to the present invention;

FIG. 2 is a magnified view showing the area A shown in FIG. 1;

FIG. 3 is a sectional assembly view of the security tag shown in FIG. 1;

FIG. 4 is a sectional assembly view showing a security tag according to a first embodiment of the present invention;

FIG. 5 is an illustrative view showing an application according to the security tag shown in FIG. 4;

FIG. 6 is a sectional assembly view showing a security tag according to a second embodiment of the present invention;

FIG. 7 is an illustrative view showing an application according to the security tag shown in FIG. 6;

FIG. 8 is a sectional assembly view showing a security tag according to a third embodiment of the present invention;

FIG. 9 is an illustrative view showing an application according to the security tag shown in FIG. 8;

FIG. 10 is a sectional assembly view showing a security tag according to a fourth embodiment of the present invention;

FIG. 11 is an illustrative view showing an application according to the security tag shown in FIG. 10;

FIG. 12 is a flow chart showing a method of manufacturing a security tag according to the present invention;

FIG. 13 is a top view showing security tags in a tape and reel package according to an embodiment of the present invention; and

FIG. 14 is an illustrative view showing a manufacturing process according to the security tags in the tape and reel package shown in FIG. 13.

### DETAILED DESCRIPTION OF THE PREFERRED EMBODIMENTS

The objective of the present invention will no doubt become obvious to those of ordinary skill in the art after reading the following detailed description of the preferred embodiment, which is illustrated in the various figures and drawings.

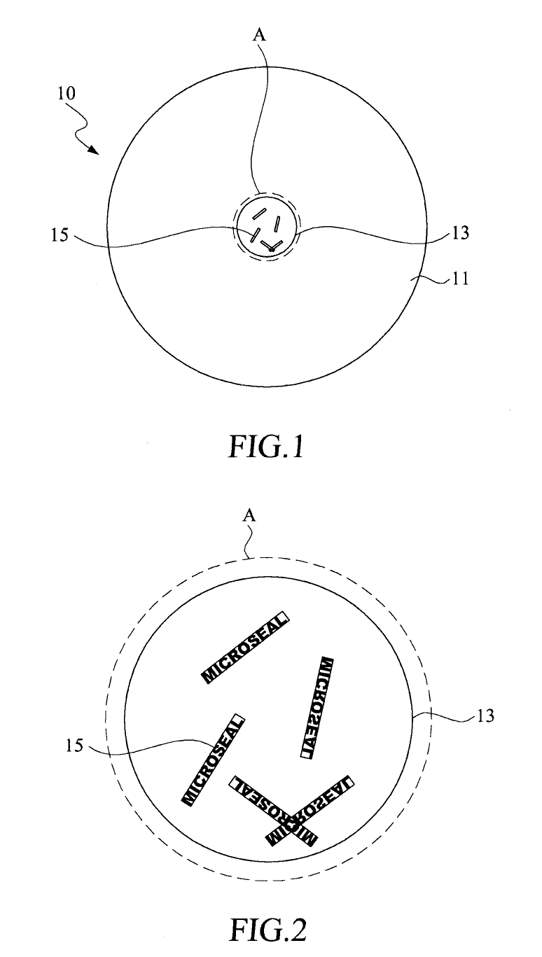

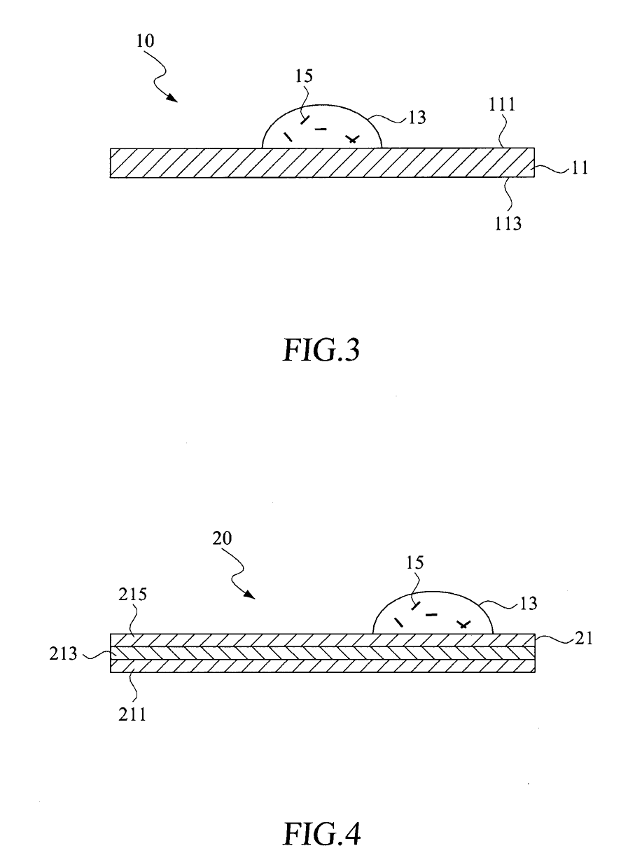

Firstly, please refer to FIG. 1 to FIG. 3 together. FIG. 1 is a top view that illustrates a security tag according to the present invention, FIG. 2 is a magnified view showing the area A shown in FIG. 1, and FIG. 3 is a sectional assembly view of the security tag shown in FIG. 1.

As shown in FIG. 1 to FIG. 3, a security tag 10 includes a carrier film 11, a transparent glue 13 and a plurality of micro-sheets 15. The carrier film 11 has a top surface 111 and a corresponding bottom surface 113, and the transparent glue 13 is disposed on the top surface 111. Each micro-sheet 15 is provided with a specific engraved pattern with dimensions in the micron range that includes the micron level and under the micron level. Before solidification, the transparent glue 13 and the micro-sheets 15 are mixed together in advance and then dropped on the carrier film 11 for solidification. The micro-sheets 15 are randomly distributed within the transparent glue 13 and compose a unique feature. The unique feature is hardly reproduced and could provides an authentication for an article, such as an electrical device, a certificate, a paper document, or etc.

It should be noted that as long as there is at least one micro-sheet 15 inside the transparent glue 13, the security tag 10 could be used to give an authentication. The drawings herein take multiple micro-sheets only for an illustrative example but not for limiting the quantity of the micro-sheet 15.

The carrier film 11 carrying the transparent glue 13 and the micro-sheets 15 is a key component for attaching the security tag 10 onto the surface of an article. The security tag 10 could be attached onto different articles with dissimilar material by flexibly changing the species of the carrier film 11. This feature will be illustrated in detail hereinafter by several embodiments.

The transparent glue 13 is used to adhere the micro-sheets 15 on the carrier film 11. The transparent glue 13 could be full transparent or half transparent on condition that the inside micro-sheets 15 are visible and the species thereof could be ultraviolet (UV) glue, thermal glue, instant glue, or etc. Among these kinds of glue, UV glue solidified by UV light has short curing time and is stable for keeping from solidification in room temperature so that it is suitable for the fabrication processes of mixing and de-aeration. Hence, UV glue is suggested for production. Moreover, toner powder could be added into the transparent glue 13 to give the transparent glue 13 a specific color for indication, classification or other causes.

The micro-sheet 15 is formed from a ceramic substrate, such as a silicon substrate, or a metal substrate, such as an aluminum substrate. The specific engraved pattern of the micro-sheet 15 is fabricated by applying micro-engraving manufacturing process on the substrate. The specific engraved pattern could be a trademark, one or multiple words, a special mark, or other patterns required by customers. The manufacture at the micron level would raise difficulties of reproduction of the micro-sheets 15 substantially so as to prevent the security tag 10 from being copied. During identification, one could aim at the transparent glue 13 by an auxiliary tool, such as a magnifier or a microscope, and observe the micro-sheets 15 in a magnified view for certification.

According to an embodiment, the specific engraved pattern of the micro-sheet 15 is fabricated by applying a micro-electro-mechanical manufacturing process on the substrate. Currently, micro-electro-mechanical manufacturing process could perform manufacture at the nanometer level so that the required dimensions in the micron range of the micro-sheet 15 could be satisfied.

It should be noted that there are still many ways to fabricate the micro-sheets 15. For example, U.S. Pat. No. 6,708,618 also discloses a way to make the micro-sheet 15.

In production, the transparent glue 13 and the micro-sheets 15 are mixed together in advance and then installed into a container. The transparent glue 13 mixed with micro-sheets 15 are dropped onto the top surface 111 of the carrier film 11 for solidification by a glue dispenser. The shape of the transparent glue 13 on the carrier film 11 could be a dot, a bar, or other shape. Because the transparent glue 13 is with strong viscosity, the solidified transparent glue 13 would has a dome configuration. If the dome configuration does not meet an application requirement, the producer could further press the solidified transparent glue 13 by a tool so as to make the dome configuration even.

The security tag 10 could be attached onto different articles with dissimilar material by flexibly designing the species of the carrier film 11. Four embodiments are illustrated hereinafter.

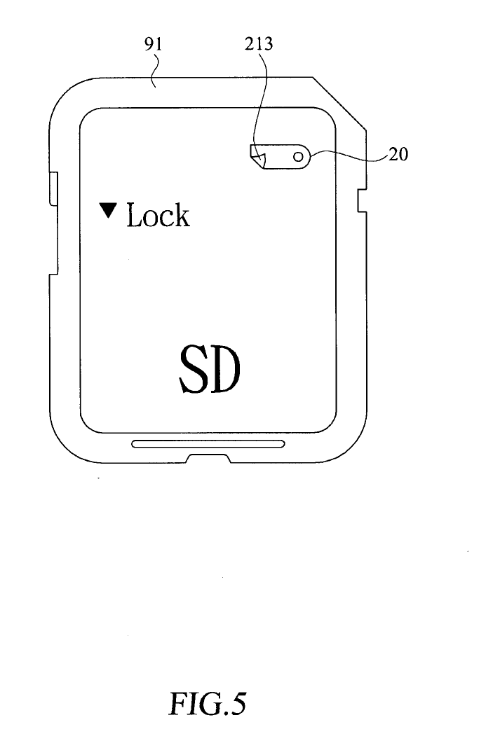

Please refer to FIG. 4 and FIG. 5. FIG. 4 is a sectional assembly view showing a security tag according to a first embodiment of the present invention, and FIG. 5 illustrates an application of the security tag shown in FIG. 4. According to the embodiment, the carrier film 21 of the security tag 20 is a sticker including a cover layer 211, an adhesive layer 213 and a base layer 215. These three layers are overlapped. The adhesive layer 213 is interposed between the cover layer 211 and the base layer 215, and the base layer 215 is configured to carry the transparent glue 23 mixed with the micro-sheets 25 used for authentication. As shown in FIG. 5, by tearing off the cover layer 211, the adhesive layer 213 would be revealed for attaching the security tag 20 onto the surface or the package of the article 91.

Besides, in order to avoid the security tag 20 being reused, self destructive stickers, security stickers and tamper proof stickers are the suggested species of the carrier film 21. Once the security tag 20 is torn off from the article 91, the structure of the security tag 20 will be destroyed in the meanwhile so that the reuse could be prevented. In addition, the carrier film 21 could be a transparent sticker for hiding the authentication mark.

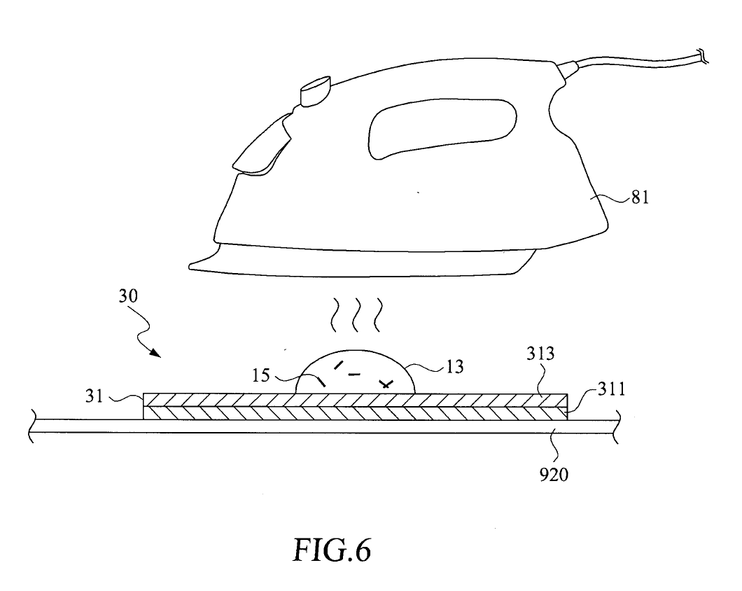

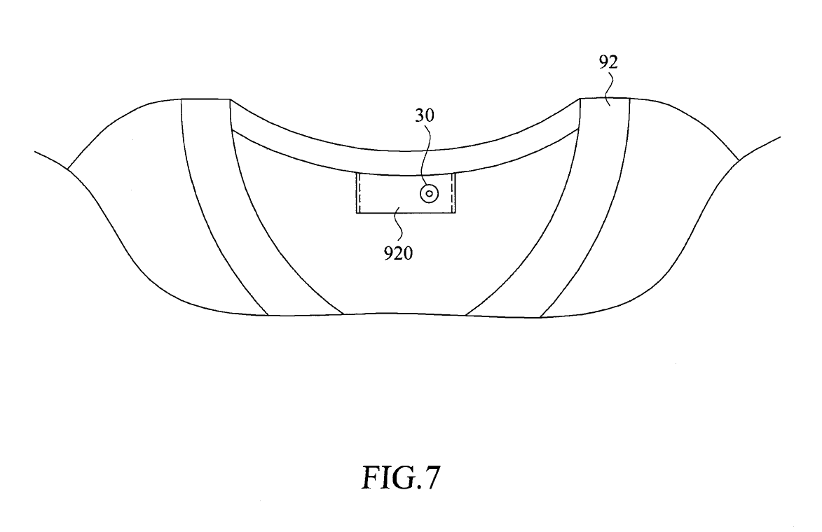

Following, please refer to FIG. 6 and FIG. 7. FIG. 6 is a sectional assembly view showing a security tag according to a third embodiment of the present invention, and FIG. 7 illustrates an application of the security tag shown in FIG. 6. The embodiment focuses on an application of textile. The carrier film 31 of the security tag 30 is a heat-transfer film including an adhesive heat-transfer layer 311 and a base layer 313. Products, such as clothes, shoes, and bags usually have a textile label (as the label 920 shown in FIG. 6 and FIG. 7). As shown in FIG. 6, by applying heat and pressure onto the surface of the base layer 313 with a press tool 81, the adhesive heat-transfer layer 313 will be melted and then stick the security tag 30 onto the label 920.

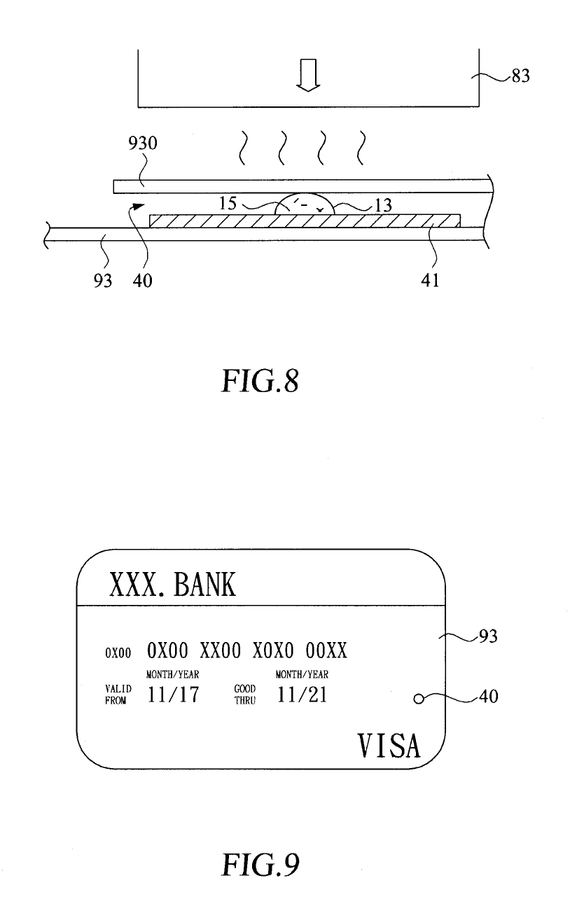

Please refer to FIG. 8 and FIG. 9. FIG. 8 is a sectional assembly view showing a security tag according to a third embodiment of the present invention, and FIG. 9 illustrates an application of the security tag shown in FIG. 8. The embodiment focuses on an application of plastic cards, such as credit cards. The carrier film 41 is a polymer film. The material of the polymer film could be PVC, PET, OPP, or etc. A polymer film can be stuck between two plastic layers by heat. As shown in FIG. 8, the security tag 40 is placed on a pre-determined position of the article 93, and another plastic protection film 930 is placed thereon. By applying heat and pressure onto the overlapped protection film 930, the security tag 40 and the article 93 by a press tool 83, the carrier film 41 will be melted so as to stick the protection film 930 and the security tag 40 together on the surface of the article 93.

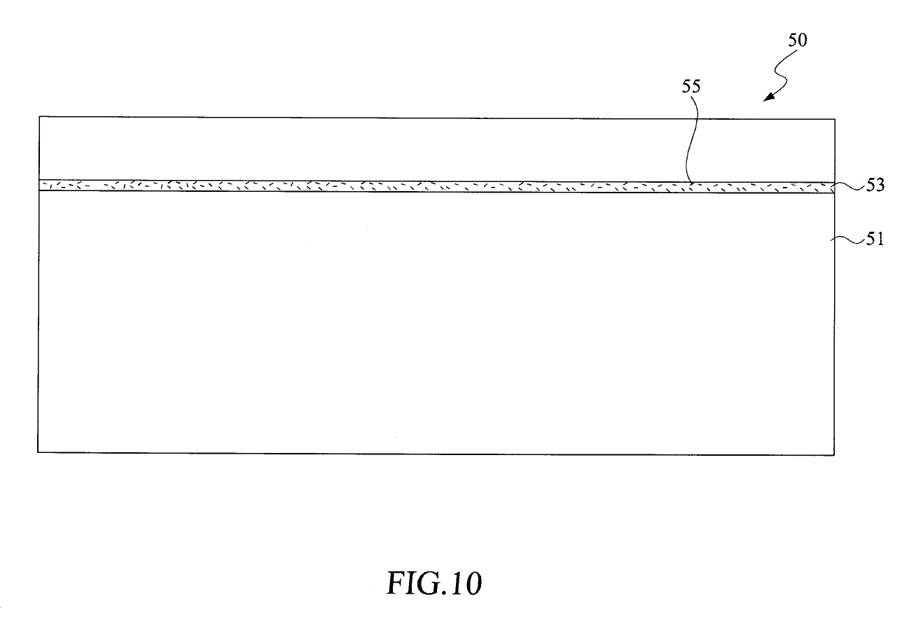

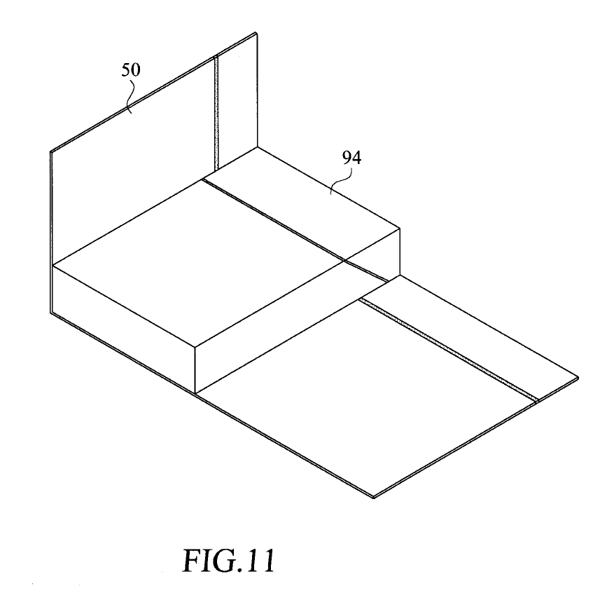

Please refer to FIG. 10 and FIG. 11. FIG. 10 is a sectional assembly view showing a security tag according to a fourth embodiment of the present invention, and FIG. 11 illustrates an application of the security tag shown in FIG. 10. Differing from the previous embodiments, in the fourth embodiment, the carrier film 51 of the security tag 50 has a larger area and the shape of the transparent 53 mixed with micro-sheets 55 is a bar. The security can be applied to package an article 94. As shown in FIG. 11, a cigarette box is taken for an illustrative example. The carrier film 51 could be a polymer film and the material of the polymer film could be OPP or DOPP.

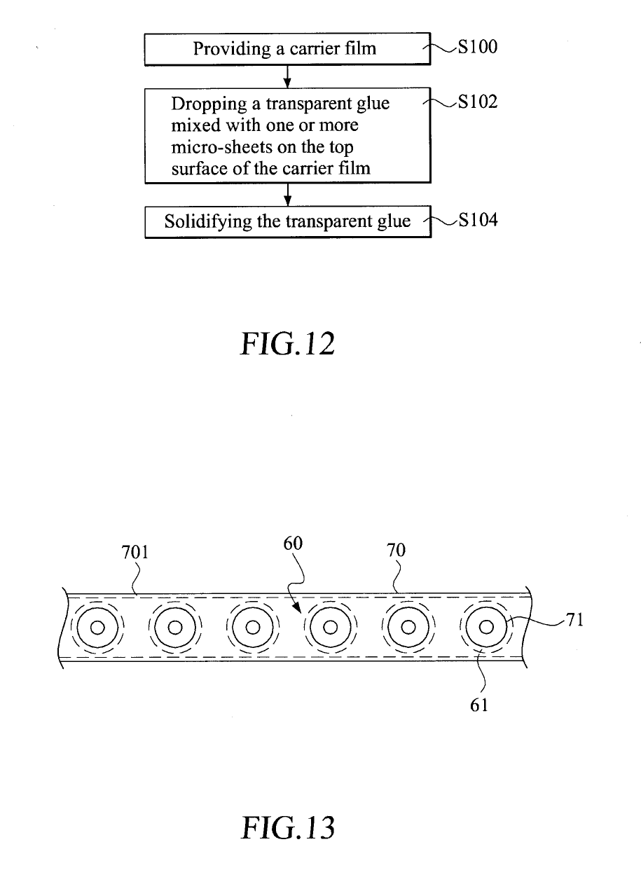

Afterwards, a method of manufacturing a security tag will be illustrated. Please refer to FIG. 12 that is a flow chart showing the method. Please refer to FIG. 1 to FIG. 3 for referring the mentioned structure. As shown in FIG. 12, the method includes the following steps.

Firstly, the step S100 is performed to provide a carrier film 11.

Next, the step S102 is performed to drop a transparent glue 13 mixed with the micro-sheets 15 on the top surface 111 of the carrier film 11.

Last, the step S104 is performed to solidify the transparent glue 13.

After the step S104, the method could further perform the step of pressing the solidified transparent glue 13 by a tool so as to make the shape thereof even.

The security tag could be made by automatic production and made up in a tape and reel package, a scroll package or a sheet package for being integrated into customers' production.

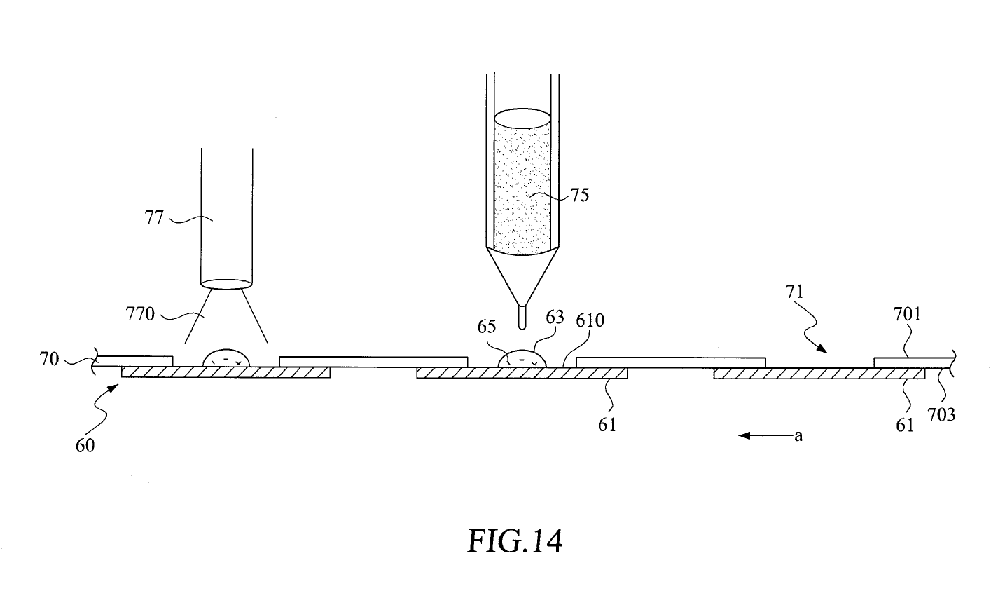

Please refer to FIG. 13 and FIG. 14. FIG. 13 is a top view showing security tags in a tap and reel package according to an embodiment of the present invention, and FIG. 14 illustrates a manufacturing process of the security tags in the tape and reel package shown in FIG. 13. As shown in FIG. 13 and FIG. 14, a carrier tape 70 includes a top surface 701 and a corresponding bottom surface 703. A plurality of openings 71 are arranged on the carrier tape 70 in order. Each opening 71 is configured to receive a security tag 60 attached thereon. The top surface 610 of the carrier film 61 of the security tag 60 is stuck on the bottom surface 703 of the carrier tape 70 so as to reveal partial top surface 610 of each carrier film 61.

In the embodiment, solidification is accomplished by UV light. During manufacturing, the container 75 and the UV light generator 77 is set on the production line. The carrier tape 70 is controlled to move along the direction a so that each carrier film 61 will pass the container 75 and the UV light generator 77 in sequence. Transparent glue and micro-sheets are mixed together and installed in the container 75. A glue dispenser not shown in the drawing controls the container 75 to feed a drop of transparent glue 63 on the carrier film 61 through the opening 71. The transparent glue 63 is then transported to receive the UV light outputted by the UV light generator 77 for solidification.

The above illustration only shows the production of the security tags of the present invention briefly. Similarly, the security tags could be produced in a scroll package, a sheet package, or etc.

Therefore, through the embodiment illustrated above, one should realize that the security tag and the method of manufacturing the same according to the present invention provides a carrier film to carry a transparent glue and one or more micro-sheets. Thus, the security tag could be attached onto different articles with dissimilar material varying from customer requirements by flexibly changing the species of the carrier film. Besides, the manufacture at the micron level of fabricating the micro-sheet with a specific engraved pattern would raise difficulties of copying the security tag substantially. Moreover, the micro-sheets are randomly distributed within the transparent glue and compose a unique feature that is hardly reproduced. The unique feature could provide an authentication for an article. Apparently, the security tag according to the present invention has multiple superior features for authentication concurrently.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A security tag, comprising:
a carrier film, comprising a top surface;
a transparent glue, disposed on the top surface of the carrier film; and
at least one micro-sheet, randomly disposed inside the transparent glue, and provided with a specific engraved pattern with dimensions in the micron range.

2. The security tag according to claim 1, wherein the carrier film is a sticker.

3. The security tag according to claim 2, wherein the sticker comprises a cover layer, an adhesive layer and a base layer, the adhesive layer is interposed between the cover layer and the base layer, and the base layer is configured to carry the transparent glue.

4. The security tag according to claim 2, wherein the sticker is one selected from the group consisting of a self destructive sticker, a security sticker, a transparent sticker and a tamper proof sticker.

5. The security tag according to claim 1, wherein the carrier film is a heat-transfer film.

6. The security tag according to claim 5, wherein the heat-transfer film comprises a base layer and an adhesive heat-transfer layer.

7. The security tag according to claim 1, wherein the carrier film is a polymer film.

8. The security tag according to claim 7, wherein the material of the polymer film is one selected from the group consisting of PVC, PET, OPP and DOPP.

9. The security tag according to claim 1, wherein the raw material of the transparent glue comprises one selected from the group consisting of ultraviolet (UV) glue, thermal glue, and instant glue.

10. The security tag according to claim 9, wherein the raw material of the transparent glue further comprises a toner powder.

11. The security tag according to claim 1, wherein the micro-sheet consists of ceramics.

12. The security tag according to claim 1, wherein the micro-sheet consists of metal.

13. A method of manufacturing a security tag, comprising the steps of:
providing a carrier film;
dropping a transparent glue mixed with at least one micro-sheet, which is provided with a specific engraved pattern with dimensions in the micron range, on a top surface of the carrier film; and
solidifying the transparent glue.

14. The method according to claim 13, further comprising the step of:
pressing the transparent glue so as to make the shape of the transparent glue even.

15. The method according to claim 13, wherein the micro-sheet is randomly distributed within the transparent glue.

16. The method according to claim 13, wherein the micro-sheet is fabricated from a substrate.

17. The method according to claim 16, wherein the micro-sheet is formed by applying a micro-electro-mechanical manufacturing process on the substrate.
